(19) United States
(12) Patent Application Publication
(10) Pub. No.: US 2006/0283888 A1
(43) Pub. Date: Dec. 21, 2006

(54) Container with air freshener

(75) Inventors: Kevin M. Kinscherf, Freehold, NJ (US); Barbara Thomas, Princeton, NJ (US); Salvatore Del'Re, Marlboro, NJ (US)

Correspondence Address: COLGATE-PALMOLIVE COMPANY, 909 RIVER ROAD, PISCATAWAY, NJ, 08855, US

(73) Assignee: Colgate-Palmolive Company

(21) Appl. No.: 11/156,166

(22) Filed: Jun. 17, 2005

(51) Int. Cl. B67D 1/07

(52) U.S. Cl. 222/192

(57) ABSTRACT

A container for a household product has as a part of its structure a passive delivery system for a room freshening fragrance. Associated with an upper portion of the container is a tray unit with a plurality of separate compartments. Each compartments contains the same or a different air freshening fragrance. Further each compartment can be opened separately as a way to control amount of the delivery of the air freshening fragrance to a room. In a preferred embodiment the compartments can be closed when no fragrance delivery is desired.

### FIELD OF THE INVENTION

This invention relates to the combination of an air freshener and a container. More particularly this invention relates to a multi-compartment air freshener unit that is associated with the neck of a container.

### BACKGROUND OF THE INVENTION

Various containers for products are used in the rooms of a dwelling. This particularly is the case with regard to the kitchen. Containers of cleaning products such as dishwashing detergents are left on countertops since they are in constant use through a day. Such containers can provide a dual purpose. With a combination of an air freshener and a container of dishwashing detergent the air in a kitchen can be freshened to remove cooking and other odors. Such a unit also can be used in a restroom when the container is one to provide a liquid hand soap. It also is very advantageous if the air freshener also can be controlled with regard to the rate of the dispensing of a refreshing a fragrance. This can be accomplished with the present air freshening unit.

### BRIEF SUMMARY OF THE INVENTION

The present invention is directed to a container with an associated air freshener. The container has a container body, container shoulder and a container neck. A multi-compartment air freshener unit is associated with the neck of the container. Each compartment has a closure whereby upon the serial removing of the closures the fragrances from the air freshener can be dispensed over a longer period of time. This period of time can be continuous or intermittent depending on the timing of the opening of compartment closures.

The air freshener unit can be supported by the container neck, the container shoulder and/or the container closure. The closure for the compartment of the multi-compartment unit can be a reclosable closure or a foil closure that is peeled away or punctured to initiate use.

### BRIEF DESCRIPTION OF THE DRAWINGS

FIG. 1 is a perspective view of the container with a multi-compartment air freshener unit with one compartment opened.

FIG. 2 is a front elevation view of the container with a multi-compartment air freshener unit.

FIG. 3 is a side elevation view of the container with multi-compartment air freshener unit.

FIG. 4 is a top plan view of the container with a multi-compartment air freshener unit.

### DETAILED DESCRIPTION OF THE DRAWINGS

The preferred embodiments of the invention will now be disclosed in more detail with reference to the Figures in the drawings.

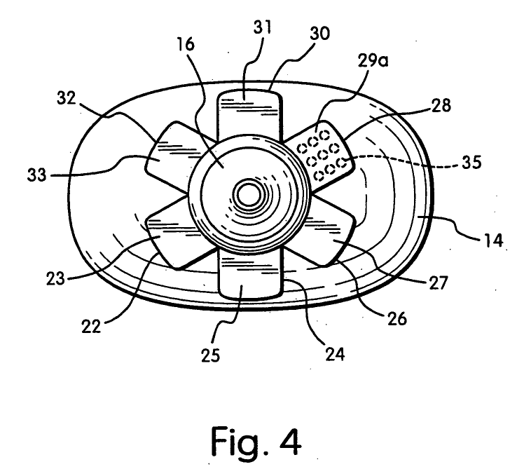

The container 10 has a body 12, base 13 and grip area 11. Above body 12 is shoulder 14 and closure 16. Below closure 16 is the multi-compartment unit. This multi-compartment unit has separate compartments 20, 22, 24, 26, 28, 30 and 32. This is better seen in FIG. 4. These compartments have closures 21, 23, 25, 27, 29, 31 and 33 respectively. The closures in a preferred embodiment are peelable seals as in shown with compartment 26 and seal 27. In an alternate embodiment the seal 27 could be punctured with a slower release of a container fragrance rather than being peeled and removed. In a further alternative embodiment a cover 30 can have a plurality of apertures 32 covered with a peelable seal similar to that of seal 27. In such a case the cover 30 remains on the compartment with the peelable seal being removed.

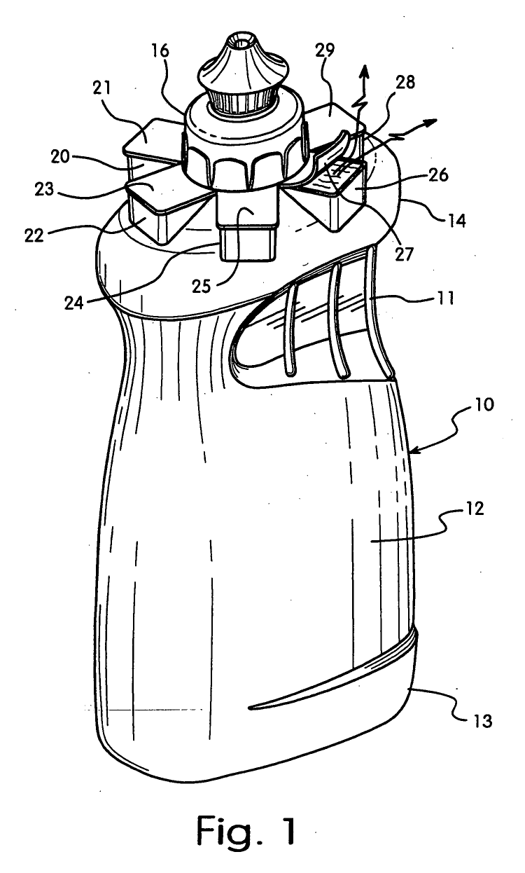

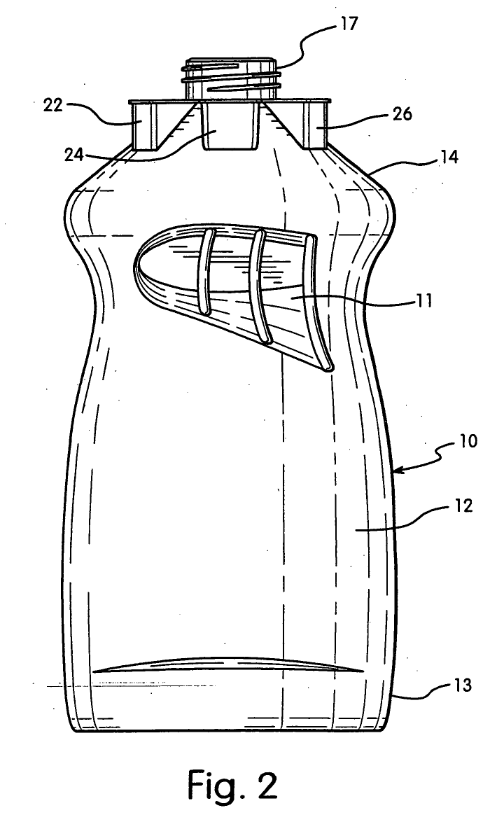

FIG. 2 is exploded front elevation view of the container of FIG. 1 showing the container neck 17. In this embodiment the neck 17 primarily supports the multi-compartment unit with the compartments partially supported by contact with shoulder 14. The closure 16 when in place will maintain the multi-compartment unit on the neck of the container.

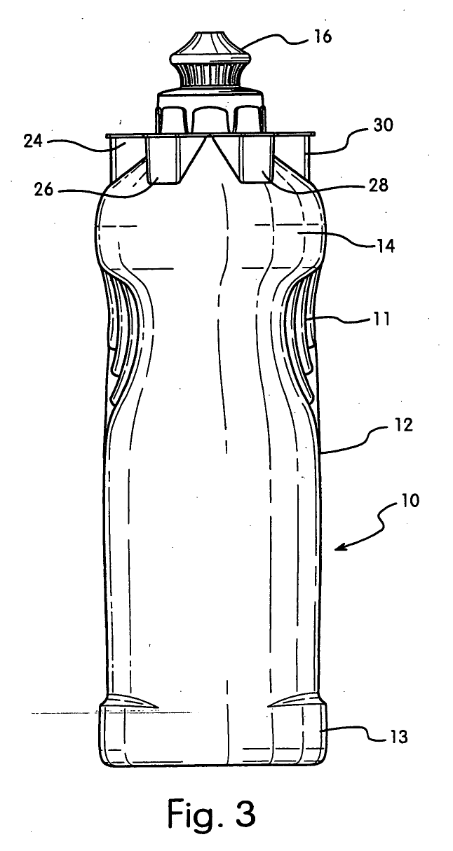

FIG. 3 is a side elevation view of the container. Compartment 26 is fully open as it is in FIG. 2. The seal 27 has been fully removed.

FIG. 4 is a top plan view of the container and multi-compartment unit air freshener. Here it is shown that unit 28 is opened the seal 27 removed but with seal component 29(a) having a plurality of apertures 35 through which a fragrance is emitted.

In use, one or more compartments of the air freshener unit will be opened and the container left on a countertop or other surface. The number of compartments opened will depend on the level of fragrance desired. The amount of fragrance delivered can be adjusted by a partial removal of the seal, or by replacing the seal on the compartment. When the fragrance in the compartments has been fully dissipated the air freshener unit can be replaced by removing the closure, then removing the spent air freshener unit, and then placing a new unit over the spout of the container. This also is a way that the fragrance can be changed.

The container usually will be made of a plastic but can be glass or another material. Useful plastics are polyethylenes, polypropylenes and polyethylene terephthalate. The multi-compartment tray can be constructed using various materials. These include various metal foils, plastics and plastic laminates. The preferred plastics are those that do not absorb fragrances. One preferred plastic is polyethylene terephthalate. The closures in a preferred embodiment will be a foil peelable seal. Useful foils are aluminum foils.

The fragrance material preferably will be a solid such as a liquid fragrance absorbed into a solid such as a saliva, alumina or a aluminasilicate such as a zeolite. The fragrance also can be a part of a plastic such as the POLYIFF products of International Flavors and Fragrances of New York, N.Y. Any if these materials will gradually desorb the fragrance over a period of time. In the structure of the present unit the seal in one or more of the compartments containing a fragrance is removed so that the fragrance can enter the room. The number that are opened will be determined by the size of the room and the strength of the cooking or other odor to be masked. Optionally a compartment can be closed when the need for fragrance is reduced.

The useful fragrances that can be used include floral scents, fresh scents, fruit scents and essentially any other desirable fragrance. The compartments can contain the same or different fragrances.

What is claimed is:

1. A combined dispensing container and air freshener comprising a container having a container body, a container shoulder and a container neck, said container shoulder on an upper part of said container body and said container neck on an upper portion of said container shoulder, a multi-compartment air freshening unit on said neck, each compartment of said freshening unit containing a fragrance.

2. A combined container and air freshener as in claim 1 wherein said container has a closure on the neck of said container.

3. A combined container and air freshener as in claim 2 wherein said closure is a dispensing closure.

4. A combined container and air freshener as in claim 2 wherein said closure maintains said multi-compartment freshening unit on the neck of said container.

5. A combined container and air freshener as in claim 1 wherein each compartment of said multi-component freshening unit has a compartment closure.

6. A combined container and air freshener as in claim 5 wherein each compartment closure is resealable.

7. A combined container and air freshener as in claim 1 wherein each compartment contains the same fragrance.

8. A combined container and air freshener as in claim 1 wherein each compartment contains a different fragrance.

9. A method of freshening the air in a room comprising placing a container of a household product in the room, said container having an upper portion thereof can air freshening unit consisting of a plurality of compartments, compartment containing an air freshening fragrance, opening the number of compartments to dispense sufficient fragrance to effectively freshen the air in a room.

10. A method as in claim 9 wherein said air freshener unit is replaced upon the air freshener fragrance in all of the compartments being dissipated.
